(19) United States
(12) Patent Application Publication
(10) Pub. No.: US 2005/0060284 A1
(43) Pub. Date: Mar. 17, 2005

(54) Management and reporting system and process for use with multiple disparate databases

(75) Inventors: Christopher M. Ruby, West Palm Beach, FL (US); Chase N. Tessman, Boca Raton, FL (US); Michael R. Langolf, Lantana, FL (US)

Correspondence Address: ARENT FOX KINTNER PLOTKIN & KAHN, 1050 CONNECTICUT AVENUE, N.W., SUITE 400, WASHINGTON, DC, 20036, US

(73) Assignee: OCWEN TECHNOLOGY XCHANGE, INC.

(21) Appl. No.: 10/957,689

(22) Filed: Oct. 5, 2004

Related U.S. Application Data
(62) Division of application No. 10/102,104, filed on Mar. 19, 2002.

(51) Int. Cl. G06F 7/00

(52) U.S. Cl. 707/1

(57) ABSTRACT

An information and reporting system is used in conjunction with a plurality of incompatible legacy system databases. The legacy system applications and databases continue to operate in a normal manner. The information and reporting system operates as an overlay to each of the existing legacy systems. Each local system includes a unique entity transfer that reads specified files from a legacy system database. The data within the legacy system database is mapped into a group of predefined XML documents which are transmitted to an XML service. The XML service provides a quality control examination and forwards the XML documents to a set of domain entity controllers. The controllers receive the XML documents and selectively extract data from these documents and store the data on a common format database, which is standardized for use in all of the local systems. A user accesses the system through a communication medium and is provided with a user interface which allows the user to select any one of a group of entities, reports and file management. Each of the entities is associated with one or more modules which provides specific processing to produce information and reports. The modules can access the common format database for extracting the required information to produce the results corresponding to the module functionality. Previously produced reports can be accessed from a file repository. The system allows users to access any legacy system and process management and information modules independent of the type of local legacy database system.

### TECHNICAL FIELD OF THE INVENTION

The present invention pertains in general to network connected computer systems and in particular to common management and report generation derived from noncompatible database application systems.

### BACKGROUND OF THE INVENTION

In past years, businesses have utilized existing computer software applications, especially spreadsheet applications and relational databases, to help manage, track, and analyze asset information (data). Typically, businesses construct ad hoc systems by attaching additional applications/software as needed to a legacy system. The result is a system that is not conducive to a dynamic business environment, although it may satisfy the internal business requirements.

As the business environment changes, the ad hoc system, due to its inflexibility, cannot adapt to major changes in the legacy system nor can the ad hoc system be implemented externally without substantial programmatic rewrites. In light of this inherent inflexibility, there exists a need for an application that can robustly manage assets and yet maintain flexibility in order to adapt to the ever-changing business environment, including external implementations. Further, such a system must be able to accommodate growth, new entity relationships and allow remote access without the need to modify the existing basic architecture.

### SUMMARY OF THE INVENTION

A selected embodiment of the invention is an information management and reporting system which operates concurrently with a plurality of different, operational legacy database systems. The system is accessible by multiple users from remote locations for reviewing information from the legacy databases and generating reports from these database systems. The information management and reporting system includes a plurality of common format databases which are associated respectively with each of the legacy database systems. A plurality of database mappers are associated respectively with each of the legacy database systems. Each of the database mappers reads data from multiple fields of the corresponding legacy database system and writes the data read from these systems into a common format database associated with the corresponding legacy database system. A plurality of applications are stored in association with each of the legacy database systems. Each of the applications accesses the corresponding common format database for data that is used by the application. Each of the applications are accessible by the multiple users through a communication medium from remote locations.

### BRIEF DESCRIPTION OF THE DRAWINGS

For a more complete understanding of the present invention, reference is now made to the following detailed description taken in conjunction with the drawings in which:

FIG. 1 is a block diagram illustrating the basic units and the intercommunications between the various aspects of the described information management and reporting system;

FIG. 2 is a flow diagram illustrating the operation of the entity transfer shown in FIG. 1;

FIG. 3 is an illustration of the mapping of data fields as performed by the entity transfer;

FIG. 4 is a block diagram showing the transfer of data into a common format database; and

FIG. 5 is a flow diagram of a user session for the described system.

### DETAILED DESCRIPTION OF THE INVENTION

The present invention is a method and product for managing information and generating reports that are derived from a group of different, operationally ongoing legacy database systems. These systems are accessible by multiple users for reviewing information, organizing actions and generating reports.

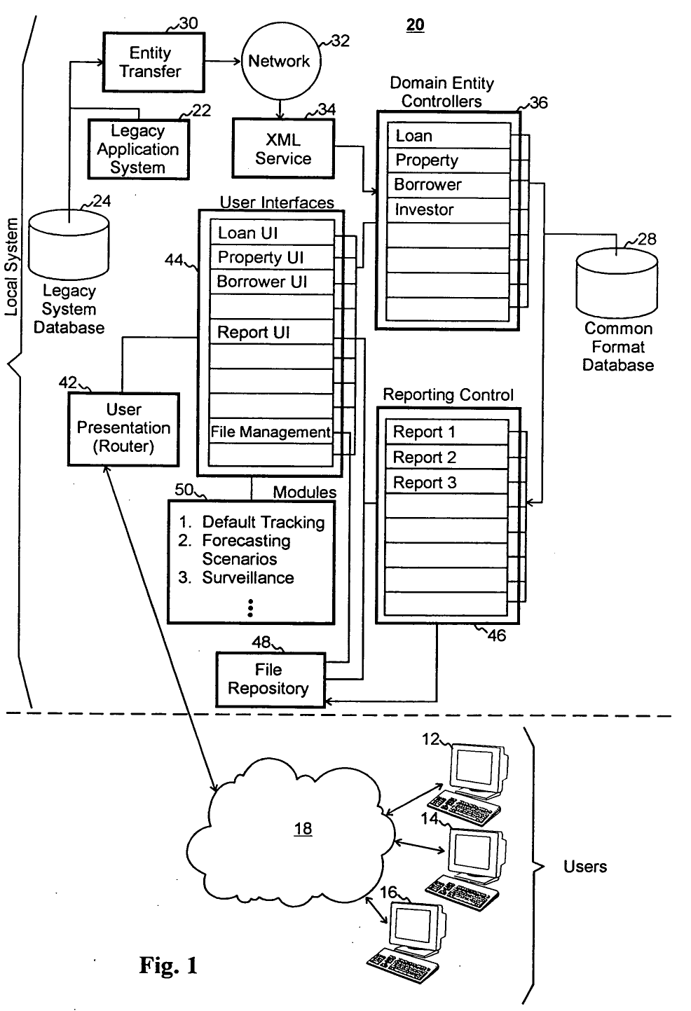

Referring to FIG. 1, there is shown a group of users including 12, 14, and 16, which communicate through a medium 18 to one of a plurality of local systems, one such system shown as local system 20. The medium 18 can be, for example, the Internet or a telecommunications system such as the public telephone network.

The local system 20 includes an operating legacy database system which includes a legacy application system 22 and a legacy system database 24. Examples of such legacy systems include mainframe computers utilizing database software such as provided by Oracle and SAP.

The legacy system interconnects with a group of overlay programs which write data to and read data from a common format database 28. The layout of data in the common format database 28 is the same in all of the multiple local systems which can be accessed by the users 12-16. Each of the local overlay programs includes an entity transfer 30 which reads data fields from the legacy system database 24 and maps these fields into a format that is common across the common format databases, such as 28. The entity transfer 30 further converts the data read from the legacy system database 24 into common XML (Extensible Markup Language) documents which are communicated through a network 32 to an XML service 34.

The XML documents are routed by the XML service 34 to domain entity controllers 36. For the described embodiment, these controllers are for the entities Loan, Property, Borrower and Investor. The documents from the XML service 34 are provided to the entities within the domain controllers 36. An XML document can provide data to multiple ones of the controllers 36. The outputs from each of the controllers 36 are communicated for storage in the common format database 28.

The users 12-16 communicate through the medium to each local system and interface with a user presentation (router) 42 which provides the interface between the user and the overlay management system located at each local system, such as 20. The user presentation 42 is connected for communication with user interfaces 44 wherein a user can be connected to any one of the interfaces 44. Communication is provided from any one of the interfaces or modules accessed within the user interfaces 44 to the input of domain controllers 36. The report user interface is connected to a reporting control 46 for use with any one of the reports therein. The report user interface of the user interfaces 44 is further connected to a file depository 48. The file management module of user interfaces 44 is also connected for communication with the file repository 48.

The reporting control 46 is further connected to transfer reports from the control 46 to the file repository 48. The reporting control 46 is also connected for communication with the common format database 28.

Modules 50 are accessed as needed by the user interfaces 44. The modules include functional operations which include default tracking, forecasting scenarios and Surveillance (Credit Risk Events, Watch List, Operating Statement Management/Analysis, Rent Roll Module). Additional modules/functionality can include Portfolio/Contract Module, Staffing/HRD Module, Conversation Log, Automated Letters, Vendor Tracking, UCC Tracking, and REO Management. Each of the modules is an application.

The operation of the information management and reporting system is described generally in reference to FIG. 1. The legacy system, which includes the application system 22 and the legacy system database 24, continues to operate in its normal manner without modification. The entity transfer 30, upon command, at scheduled times or at periodic times, reads all data from a set of specified files from the legacy system database 24 and according to a predetermined mapping scheme translates the data read from the database 24 into predefined format XML documents. Each of the XML documents is then transmitted through the network 32 to the XML service 34. Within the service 34, each document is checked for accurate formatting and content. If an error is detected, an appropriate error message is logged and reported to an operator. The operator must decide if the process should be repeated or if corrections to the legacy database 24 must be made before the entity transfer process is repeated.

If the XML documents are correct, they are transmitted from the XML service 34 to the appropriate ones of the controllers 36. The controllers 36 then transmit the respective data from the XML documents into the common format database 28. The field structure of the database 28 is predefined in a single configuration that is used by all of the local systems. Each of the controllers in controller 36 can receive data from all of the XML documents and each controller writes its relevant data into selected fields in the common format database 28.

The entity transfer 30 can read all of the files from the legacy system database 24 and transfer the data from these files through the network 32, XML service 34 and controllers 36 to overwrite the previous information in the common format database 28, or if supported by the legacy system database 24, only read and transfer those data entries that have changed or been added since the last read of data from the database 24.

Referring to FIG. 1, the user 12 logs on through the medium 18 to the user presentation 42, and after appropriate security information is provided, is permitted to select from a menu for selecting any one of the user interfaces within the user interfaces 44. The user is restricted to only that data for which he is permitted to have access. The user accesses the system for obtaining information by selecting any one of the available interfaces such as Loan, Property, Borrower, Report or File Management Report. The ones of the modules 50 required to perform a requested operation are accessed from the user interfaces 44. If, for example, the user 12 has selected Property in the user interface 44, the user can then select specific information related to a particular property and this information is retrieved via the controllers 36 from the common format database 28. The user 12 can likewise select a particular report through the report user interface and this can be derived by the reporting control 46 for a new report or a historical report can be retrieved from the file repository 48. Whenever a report is generated, that report can be stored, at the operator's option, in the reporting control 46 for future access since report generating is typically a time consuming activity.

Each of the operational blocks of the local system shown in FIG. 1, which includes blocks 30, 34, 36, 42, 44, 46, 48 and 50 can be operated on one or more processing systems which can communicate with the local legacy application system, such as 22. Optionally, these functional blocks may be distributed among various processing systems as appropriately determined by processing capability, communications interface and availability. The network 32 is shown as a representative communication between blocks 30 and 34, however, these could be directly connected or network interconnections could be provided between other functional blocks within the local system 20 shown in FIG. 1.

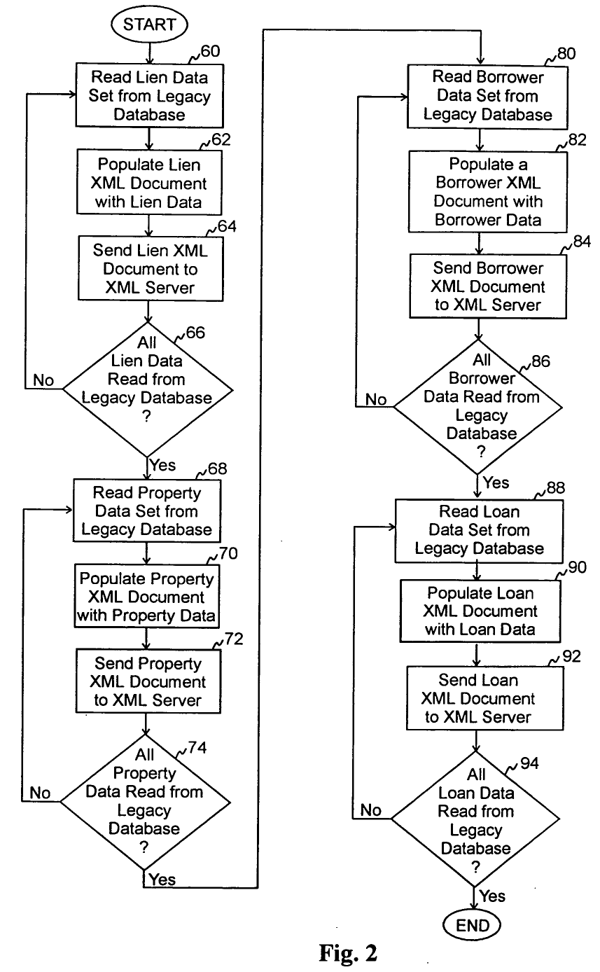

A flow diagram illustrating the operation of the entity transfer 30 is shown in FIG. 2. Following the start, which can be initiated in multiple ways as described above, the entity transfer 30 reads a lien data set from a legacy database 24 for a particular lien. This is done in block 60. In a following block 62, the lien data read from the data base 24 is populated into a lien XML document (see Table 1 below). In a sequential block 64, the lien XML document thus produced is sent to the XML server 34. Following block 64, entry is made to a question block 66 in which a determination is made if there is any further lien data remaining to be read from the legacy database 24. If not, entry is made back to block 60 to repeat the process and generate another lien XML document. If yes, entry is made to block 68.

In functional block 68, the entity transfer 30 reads a property data set from the legacy database 24 and then a block 70 populates an XML document (see Table 2 below) using this property data. In a following block 72, the property XML document is sent to the XML server. Next, in question block 74, a determination is made if all property data has been read from the legacy database 24. If not, return is made to block 68. If all property data has been read, operation is transferred to a block 80.

In the functional block 80, the entity transfer 30 reads the borrower data set from the legacy database 24 and in block 82 populates a borrower XML document (see Table 3 below) with the borrower data read from the database. In a next block 84, the borrower XML document is sent to the XML server. In a following question block 86, an inquiry is made to determine if all borrower data has been read from the legacy database. If not, entry is made back to block 84 to repeat the process and produce another borrower XML document. If all borrower data has been read from the legacy database, control is transferred through the yes output to block 88.

In block 88, the entity transfer 30 reads a loan data set from the legacy database and in block 90, uses this loan data to populate a loan XML document (see Table 4 below). In the sequential block 92, the loan XML document is transmitted to the XML server 34. In a following question block 94, the determination is made if all loan data has been read from a legacy database 24. If not, return is made to the block 88 to produce a next loan XML document. If all loan data has been read from the legacy database 24, the yes exit is taken to complete the process at the end of the sequence.

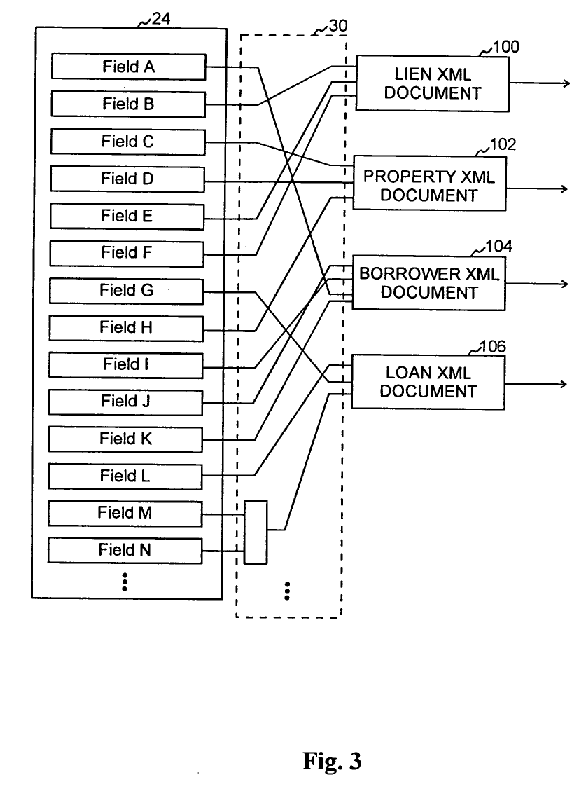

The mapping function of the entity transfer 30 is illustrated in FIG. 3. The legacy system database 24 is illustrated as having a plurality of fields labeled from A through N and continuing as needed to include all of the data within such a system. The entity transfer 30 performs a mapping function to extract the specific information from the database 24 and utilize that information to populate the appropriate one of the documents which include the lien XML document 100, the property XML document 102, the borrower XML document 104 and the loan XML document 106. For example, the property XML document 102 utilizes data from fields C, D, and H. The data in these fields are mapped into specific fields in the XML document 102. More complex operations can be performed, such as combining data from multiple fields for a single input into a document. This is shown, for example, in the combination of fields M and N from the database 24 to be used within the loan XML document 106. All fields used from the legacy database are mapped into specific fields of the documents 100, 102, 104 and 106.

As seen in the description of FIG. 3, each entity transfer 30 for a local system must be designed with mapping specifically to operate with that local system. However, the resulting documents 100-106 are standardized across all of the local systems, one such system shown as 20, and thus the operations performed by the overlay programs, such as in the main entity controllers 36, the user interfaces 44 and the modules 50 correspond to the standard format layout in the XML documents and are therefore independent of the local system legacy database 24.

FIG. 3 is representative of the data mapping and may include hundreds of field mapping relationships.

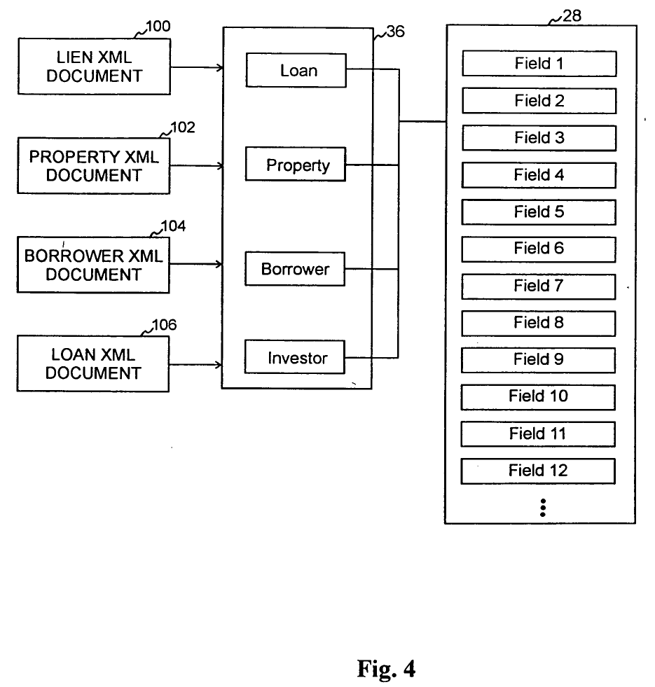

Document type definitions (DTD) representations for XML documents, as illustrated in FIGS. 3 and 4, are presented in the following tables wherein Table 1 corresponds to Lien XML document 100, Table 2 corresponds to Property XML document 102, Table 3 corresponds to Borrower XML document 104 and Table 4 corresponds to Loan XML document 106. XML documents are structured format documents.

TABLE 1

<!-- DTD for Lien -->
<!ELEMENT vg_lien
(interest_rate,last_paid_date,lien_balance,
lien_number,lien_orig_bal,lien_type_id,maturity_{—}
date,next_paid_date,payment)>
<!ELEMENT interest_rate (#PCDATA)>
<!ATTLIST interest_rate datatype (D|N|T) “N” >
<!ELEMENT last_paid_date (#PCDATA)>
<!ATTLIST last_paid_date datatype (D|N|T) “D” >
<!ELEMENT lien_balance (#PCDATA)>
<!ATTLIST lien_balance datatype (D|N|T) “N” >
<!ELEMENT lien_number (#PCDATA)>
<!ATTLIST lien_number datatype (D|N|T) “T” >
<!ELEMENT lien_orig_bal (#PCDATA)>
<!ATTLIST lien_orig_bal datatype (D|N|T) “N” >
<!ELEMENT lien_type_id (#PCDATA)>
<!ATTLIST lien_type_id datatype (D|N|T) “N” >
<!ELEMENT maturity_date (#PCDATA)>
<!ATTLIST maturity_date datatype (D|N|T) “D” >
<!ELEMENT next_paid_date (#PCDATA)>
<!ATTLIST next_paid_date datatype (D|N|T) “D” >
<!ELEMENT payment (#PCDATA)>
<!ATTLIST payment datatype (D|N|T) “N” >

TABLE 2
<!-- DTD for Property -->
<!ELEMENT vg_property
(acq_mkt_value,acq_prop_name,
acq_units,address_line1,address_line2,address_line3,apn,
back_taxes,block,city,cond_type_id,
condo_fee,country_code,gla_unit_id,hoa_fee,ingress_egress,
insurance,land_area,land_unit_id,
legal_desc,location,lot,nla_unit_id,owner_occup_percnt,
owner_type_id,parcel,postal_code,prop_gla,
prop_name,prop_nla,prop_number,
prop_units,real_estate_taxes,resol_mkt_value,
s_p_flag,section,state_province_code,title_{—}
policy,title_policy_date,township,vacant,year_built,
year_renovated,zoning,vg_prop_valuation*,
vg_prop_lien_link*)>
<!ELEMENT acq_mkt_value (#PCDATA)>
<!ATTLIST acq_mkt_value datatype (D|N|T) “N” >
<!ELEMENT acq_prop_name (#PCDATA)>
<!ATTLIST acq_prop_name datatype (D|N|T) “T” >
<!ELEMENT acq_units (#PCDATA)>
<!ATTLIST acq_units datatype (D|N|T) “N” >
<!ELEMENT address_line1 (#PCDATA)>
<!ATTLIST address_line1 datatype (D|N|T) “T” >
<ELEMENT address_line2 (#PCDATA)>
<!ATTLIST address_line2 datatype (D|N|T) “T” >
<!ELEMENT address_line3 (#PCDATA)>
<!ATTLIST address_line3 datatype (D|N|T) “T” >
<!ELEMENT apn (#PCDATA)>
<!ATTLIST apn datatype (D|N|T) “T” >
<!ELEMENT back_taxes (#PCDATA)>
<!ATTLIST back_taxes datatype (D|N|T) “N” >
<!ELEMENT block (#PCDATA)>
<!ATTLIST block datatype (D|N|T) “T” >
<!ELEMENT city (#PCDATA)>
<!ATTLIST city datatype (D|N|T) “T” >
<!ELEMENT cond_type_id (#PCDATA)>
<!ATTLIST cond_type_id datatype (D|N|T) “N” >
<!ELEMENT condo_fee (#PCDATA)>
<!ATTLIST condo_fee datatype (D|N|T) “N” >
<!ELEMENT country_code (#PCDATA)>
<!ATTLIST country_code datatype (D|N|T) “T” >
<!ELEMENT gla_unit_id (#PCDATA)>
<!ATTLIST gla_unit_id datatype (D|N|T) “N” >
<!ELEMENT hoa_fee (#PCDATA)>
<!ATTLIST hoa_fee datatype (D|N|T) “N” >
<!ELEMENT ingress_egress (#PCDATA)>
<!ATTLIST ingress_egress datatype (D|N|T) “T” >
<!ELEMENT insurance (#PCDATA)>
<!ATTLIST insurance datatype (D|N|T) “N” >
<!ELEMENT land_area (#PCDATA)>
<!ATTLIST land_area datatype (D|N|T) “N” >
<!ELEMENT land_unit_id (#PCDATA)>
<!ATTLIST land_unit_id datatype (D|N|T) “N” >
<!ELEMENT legal_desc (#PCDATA)>
<!ATTLIST legal_desc datatype (D|N|T) “T” >
<!ELEMENT location (#PCDATA)>
<!ATTLIST location datatype (D|N|T) “T” >
<!ELEMENT lot (#PCDATA)>
<!ATTLIST lot datatype (D|N|T) “T” >
<!ELEMENT nla_unit_id (#PCDATA)>
<!ATTLIST nla_unit_id datatype (D|N|T) “N” >
<!ELEMENT owner_occup_percnt (#PCDATA)>
<!ATTLIST owner_occup_percnt datatype (D|N|T) “N” >
<!ELEMENT owner_type_id (#PCDATA)>
<!ATTLIST owner_type_id datatype (D|N|T) “N” >
<!ELEMENT parcel (#PCDATA)>
<!ATTLIST parcel datatype (D|N|T) “T” >
<!ELEMENT postal_code (#PCDATA)>
<!ATTLIST postal_code datatype (D|N|T) “T” >
<!ELEMENT prop_gla (#PCDATA)>
<!ATTLIST prop_gla datatype (D|N|T) “N” >
<!ELEMENT prop_name (#PCDATA)>
<!ATTLIST prop_name datatype (D|N|T) “T” >
<!ELEMENT prop_nla (#PCDATA)>
<!ATTLIST prop_nla datatype (D|N|T) “N” >
<!ELEMENT prop_number (#PCDATA)>
<!ATTLIST prop_number datatype (D|N|T) “T” >
<!ELEMENT prop_units (#PCDATA)>
<!ATTLIST prop_units datatype (D|N|T) “N” >
<!ELEMENT real_estate_taxes (#PCDATA)>
<!ATTLIST real_estate_taxes datatype (D|N|T) “N” >
<!ELEMENT resol_mkt_value (#PCDATA)>
<!ATTLIST resol_mkt_value datatype (D|N|T) “N” >
<!ELEMENT s_p_flag (#PCDATA)>
<!ATTLIST s_p_flag datatype (D|N|T) “T” >
<!ELEMENT section (#PCDATA)>
<!ATTLIST section datatype (D|N|T) “T” >
<!ELEMENT state_province_code (#PCDATA)>
<!ATTLIST state_province_code datatype (D|N|T) “T” >
<!ELEMENT title_policy (#PCDATA)>
<!ATTLIST title_policy datatype (D|N|T) “T” >
<!ELEMENT title_policy_date (#PCDATA)>
<!ATTLIST title_policy_date datatype (D|N|T) “D” >
<!ELEMENT township (#PCDATA)>
<!ATTLIST township datatype (D|N|T) “T” >
<!ELEMENT vacant (#PCDATA)>
<!ATTLIST vacant datatype (D|N|T) “T” >
<!ELEMENT year_built (#PCDATA)>
<!ATTLIST year_built datatype (D|N|T) “N” >
<!ELEMENT year_renovated (#PCDATA)>
<!ATTLIST year_renovated datatype (D|N|T) “N” >
<!ELEMENT zoning (#PCDATA)>
<!ATTLIST zoning datatype (D|N|T) “T” >
<!ELEMENT vg_prop_valuation
(comments,current_value,val_adj_value,val_date,
val_type_code,val_type_desc,val_type_id,
val_value,val_value_high,val_value_low)>
<!ATTLIST vg_prop_valuation relation (C|L) “C” >
<!ELEMENT comments (#PCDATA)>
<!ATTLIST comments datatype (D|N|T) “T” >
<!ELEMENT current_value (#PCDATA)>
<!ATTLIST current_value datatype (D|N|T) “T” >
<!ELEMENT val_adj_value (#PCDATA)>
<!ATTLIST val_adj_value datatype (D|N|T) “N” >
<!ELEMENT val_date (#PCDATA)>
<!ATTLIST val_date datatype (D|N|T) “D” >
<!ELEMENT val_type_code (#PCDATA)>
<!ATTLIST val_type_code datatype (D|N|T) “T” >
<!ELEMENT val_type_desc (#PCDATA)>
<!ATTLIST val_type_desc datatype (D|N|T) “T” >
<!ELEMENT val_type_id (#PCDATA)>
<!ATTLIST val_type_id datatype (D|N|T) “N” >
<!ELEMENT val_value (#PCDATA)>
<!ATTLIST val_value datatype (D|N|T) “N” >
<!ELEMENT val_value_high (#PCDATA)>
<!ATTLIST val_value_high datatype (D|N|T) “N” >
<!ELEMENT val_value_low (#PCDATA)>
<!ATTLIST val_value_low datatype (D|N|T) “N” >
<!ELEMENT vg_prop_lien_link (amount,lien_id,lien_pos,released)>
<!ATTLIST vg_prop_lien_link relation (C|L) “L” >
<!ELEMENT amount (#PCDATA)>
<!ATTLIST amount datatype (D|N|T) “N” >
<!ELEMENT lien_id (#PCDATA)>
<!ATTLIST lien_id map (lien_number) “lien_number” >
<!ATTLIST lien_id datatype (D|N|T) “N” >
<!ELEMENT lien_pos (#PCDATA)>
<!ATTLIST lien_pos datatype (D|N|T) “N” >
<!ELEMENT released (#PCDATA)>
<!ATTLIST released datatype (D|N|T) “T” >

TABLE 3
<!ELEMENT vg_borrower
(as_of_date,borr_num,company_id,
cred_score,cred_score_dt,entity_type_id,net_worth,
person_id,(vg_company|vg_person))>
<!ELEMENT as_of_date (#PCDATA)>
<!ATTLIST as_of_date datatype (D|N|T) “D” >
<!ELEMENT borr_num (#PCDATA)>
<!ATTLIST borr_num datatype (D|N|T) “T” >
<!ELEMENT company_id (#PCDATA)>
<!ATTLIST company_id datatype (D|N|T) “N” >
<!ELEMENT cred_score (#PCDATA)>
<!ATTLIST cred_score datatype (D|N|T) “N” >
<!ELEMENT cred_score_dt (#PCDATA)>
<!ATTLIST cred_score_dt datatype (D|N|T) “D” >
<!ELEMENT entity_type_id (#PCDATA)>
<!ATTLIST entity_type_id datatype (D|N|T) “N” >
<!ATTLIST entity_type_id defvalue (2|4) “2” >
<!ELEMENT net_worth (#PCDATA)>
<!ATTLIST net_worth datatype (D|N|T) “N” >
<!ELEMENT person_id (#PCDATA)>
<!ATTLIST person_id datatype (D|N|T) “N” >
<!ELEMENT vg_company
(company_name,company_typ_id,tax_id,
vg_company_address*)>
<!ATTLIST vg_company relation (C|L) “C” >
<!ELEMENT company_name (#PCDATA)>
<!ATTLIST company_name datatype (D|N|T) “T” >
<!ELEMENT company_typ_id (#PCDATA)>
<!ATTLIST company_typ_id datatype (D|N|T) “N” >
<!ELEMENT tax_id (#PCDATA)>
<!ATTLIST tax_id datatype (D|N|T) “T” >
<!ELEMENT vg_company_address
(address_line1,address_line2,address_line3,attention_to,city,
country_code,is_primary,postal_{—}
code,s_p_flag,state_province_code)>
<!ATTLIST vg_company_address relation (C|L) “C” >
<!ELEMENT address_line1 (#PCDATA)>
<!ATTLIST address_line1 datatype (D|N|T) “T” >
<!ELEMENT address_line2 (#PCDATA)>
<!ATTLIST address_line2 datatype (D|N|T) “T” >
<!ELEMENT address_line3 (#PCDATA)>
<!ATTLIST address_line3 datatype (D|N|T) “T” >
<!ELEMENT attention_to (#PCDATA)>
<!ATTLIST attention_to datatype (D|N|T) “T” >
<!ELEMENT city (#PCDATA)>
<!ATTLIST city datatype (D|N|T) “T” >
<!ELEMENT country_code (#PCDATA)>
<!ATTLIST country_code datatype (D|N|T) “T” >
<!ELEMENT is_primary (#PCDATA)>
<!ATTLIST is_primary datatype (D|N|T) “T” >
<!ELEMENT postal_code (#PCDATA)>
<!ATTLIST postal_code datatype (D|N|T) “T” >
<!ELEMENT s_p_flag (#PCDATA)>
<!ATTLIST s_p_flag datatype (D|N|T) “T” >
<!ELEMENT state_province_code (#PCDATA)>
<!ATTLIST state_province_code datatype (D|N|T) “T” >
<!ELEMENT vg_person
(comments,date_of_birth,email_address,name_first,
name_initial,name_last,ssn,vg_person
_address*,vg_person_phone_number*)>
<!ATTLIST vg_person relation (C|L) “C”>
<!ELEMENT comments (#PCDATA)>
<!ATTLIST comments datatype (D|N|T) “T” >
<!ELEMENT date_of_birth (#PCDATA)>
<!ATTLIST date_of_birth datatype (D|N|T) “D” >
<!ELEMENT email_address (#PCDATA)>
<!ATTLIST email_address datatype (D|N|T) “T” >
<!ELEMENT name_first (#PCDATA)>
<!ATTLIST name_first datatype (D|N|T) “T” >
<!ELEMENT name_initial (#PCDATA)>
<!ATTLIST name_initial datatype (D|N|T) “T” >
<!ELEMENT name_last (#PCDATA)>
<!ATTLIST name_last datatype (D|N|T) “T” >
<!ELEMENT ssn (#PCDATA)>
<!ATTLIST ssn datatype (D|N|T) “T” >
<!ELEMENT vg_person_address
(address_line1,address_line2,address_line3,address_type_id,city,
country_code,is_primary,
postal_code,s_p_flag,state_province_code)>
<!ATTLIST vg_person_address relation (C|L) “C”>
<!ELEMENT address_type_id (#PCDATA)>
<!ATTLIST address_type_id datatype (D|N|T) “N” >
<!ELEMENT vg_person_phone_number (is_primary,
num_type_id,phone_num)>
<!ATTLIST vg_person_phone_number relation (C|L) “C”>
<!ELEMENT num_type_id (#PCDATA)>
<!ATTLIST num_type_id datatype (D|N|T) “N” >
<!ELEMENT phone_num (#PCDATA)>
<!ATTLIST phone_num datatype (D|N|T) “T” >

TABLE 4
<!-- DTD for Loan -->
<!ELEMENT vg_loan
(amortization,cred_risk_id,cross_collateralized,cross_defaulted,description,disc_prem,esc,
esc_adv,first_pymt_due_dt,fixed_var,holdbacks,int_only,int_rate,last_paid_dt,loan_charge,
loan_commitment,loan_number,loan_status_id,locom_adj,margin,maturity_date,modified_{—}
by,nbv,next_due_dt,p_i_pymt,prepymt_pnlty,prev_note_holder,prin_pymt_port,recourse_{—}
type_id,reserves,secured_upb,suspense,tot_pymt,total_upb,unsecured_upb,vg_actual_{—}
loan_status*,vg_cash_trans*,vg_loan_acq?,vg_loan_orig?,vg_loan_resolution?,vg_{—}
loan_borrower_link*,vg_loan_prop_link*)>
<!ELEMENT amortization (#PCDATA)>
<!ATTLIST amortization datatype (D|N|T) “N” >
<!ELEMENT cred_risk_id (#PCDATA)>
<!ATTLIST cred_risk_id datatype (D|N|T) “N” >
<!ELEMENT cross_collateralized (#PCDATA)>
<!ATTLIST cross_collateralized datatype (D|N|T) “T” >
<!ELEMENT cross_defaulted (#PCDATA)>
<!ATTLIST cross_defaulted datatype (D|N|T) “T” >
<!ELEMENT description (#PCDATA)>
<!ATTLIST description datatype (D|N|T) “T” >
<!ELEMENT disc_prem (#PCDATA)>
<!ATTLIST disc_prem datatype (D|N|T) “N” >
<!ELEMENT esc (#PCDATA)>
<!ATTLIST esc datatype (D|N|T) “N” >
<!ELEMENT esc_adv (#PCDATA)>
<!ATTLIST esc_adv datatype (D|N|T) “N” >
<!ELEMENT first_pymt_due_dt (#PCDATA)>
<!ATTLIST first_pymt_due_dt datatype (D|N|T) “D” >
<!ELEMENT fixed_var (#PCDATA)>
<!ATTLIST fixed_var datatype (D|N|T) “T” >
<!ELEMENT holdbacks (#PCDATA)>
<!ATTLIST holdbacks datatype (D|N|T) “N” >
<!ELEMENT int_only (#PCDATA)>
<!ATTLIST int_only datatype (D|N|T) “T” >
<!ELEMENT int_rate (#PCDATA)>
<!ATTLIST int_rate datatype (D|N|T) “N” >
<!ELEMENT last_paid_dt (#PCDATA)>
<!ATTLIST last_paid_dt datatype (D|N|T) “D” >
<!ELEMENT loan_charge (#PCDATA)>
<!ATTLIST loan_charge datatype (D|N|T) “N” >
<!ELEMENT loan_commitment (#PCDATA)>
<!ATTLIST loan_commitment datatype (D|N|T) “N” >
<!ELEMENT loan_number (#PCDATA)>
<!ATTLIST loan_number datatype (D|N|T) “T” >
<!ELEMENT loan_status_id (#PCDATA)>
<!ATTLIST loan_status_id datatype (D|N|T) “N” >
<!ELEMENT locom_adj (#PCDATA)>
<!ATTLIST locom_adj datatype (D|N|T) “N” >
<!ELEMENT margin (#PCDATA)>
<!ATTLIST margin datatype (D|N|T) “N” >
<!ELEMENT maturity_date (#PCDATA)>
<!ATTLIST maturity_date datatype (D|N|T) “D” >
<!ELEMENT modified_by (#PCDATA)>
<!ATTLIST modified_by datatype (D|N|T) “T” >
<!ELEMENT nbv (#PCDATA)>
<!ATTLIST nbv datatype (D|N|T) “N” >
<!ELEMENT next_due_dt (#PCDATA)>
<!ATTLIST next_due_dt datatype (D|N|T) “D” >
<!ELEMENT p_i_pymt (#PCDATA)>
<!ATTLIST p_i_pymt datatype (D|N|T) “N” >
<!ELEMENT prepymt_pnlty (#PCDATA)>
<!ATTLIST prepymt_pnlty datatype (D|N|T) “T” >
<!ELEMENT prev_note_holder (#PCDATA)>
<!ATTLIST prev_note_holder datatype (D|N|T) “T” >
<!ELEMENT prin_pymt_port (#PCDATA)>
<!ATTLIST prin_pymt_port datatype (D|N|T) “N” >
<!ELEMENT recourse_type_id (#PCDATA)>
<!ATTLIST recourse_type_id datatype (D|N|T) “N” >
<!ELEMENT reserves (#PCDATA)>
<!ATTLIST reserves datatype (D|N|T) “N” >
<!ELEMENT secured_upb (#PCDATA)>
<!ATTLIST secured_upb datatype (D|N|T) “N” >
<!ELEMENT suspense (#PCDATA)>
<!ATTLIST suspense datatype (D|N|T) “N” >
<!ELEMENT tot_pymt (#PCDATA)>
<!ATTLIST tot_pymt datatype (D|N|T) “N” >
<!ELEMENT total_upb (#PCDATA)>
<!ATTLIST total_upb datatype (D|N|T) “N” >
<!ELEMENT unsecured_upb (#PCDATA)>
<!ATTLIST unsecured_upb datatype (D|N|T) “N” >
<!ELEMENT vg_actual_loan_status (first_of_month,status_id)>
<!ATTLIST vg_actual_loan_status relation (C|L) “C” >
<!ELEMENT first_of_month (#PCDATA)>
<!ATTLIST first_of_month datatype (D|N|T) “D” >
<!ELEMENT status_id (#PCDATA)>
<!ATTLIST status_id datatype (D|N|T) “N” >
<!ELEMENT vg_cash_trans
(investor_id,ss_amount,ss_trans_date,ss_trans_id,ss_trans_type_id)>
<!ATTLIST vg_cash_trans relation (C|L) “C” >
<!ELEMENT investor_id (#PCDATA)>
<!ATTLIST investor_id datatype (D|N|T) “N” >
<!ELEMENT ss_amount (#PCDATA)>
<!ATTLIST ss_amount datatype (D|N|T) “N” >
<!ELEMENT ss_trans_date (#PCDATA)>
<!ATTLIST ss_trans_date datatype (D|N|T) “D” >
<!ELEMENT ss_trans_id (#PCDATA)>
<!ATTLIST ss_trans_id datatype (D|N|T) “T” >
<!ELEMENT ss_trans_type_id (#PCDATA)>
<!ATTLIST ss_trans_type_id datatype (D|N|T) “T” >
<!ELEMENT vg_loan_orig
(orig_amorttization,orig_int_rate,orig_loan_amt,orig_loan_number,orig_maturity_date,
orig_payment,origion_date)>
<!ATTLIST vg_loan_orig relation (C|L) “C” >
<!ELEMENT orig_amorttization (#PCDATA)>
<!ATTLIST orig_amorttization datatype (D|N|T) “N” >
<!ELEMENT orig_int_rate (#PCDATA)>
<!ATTLIST orig_int_rate datatype (D|N|T) “N” >
<!ELEMENT orig_loan_amt (#PCDATA)>
<!ATTLIST orig_loan_amt datatype (D|N|T) “N” >
<!ELEMENT orig_loan_number (#PCDATA)>
<!ATTLIST orig_loan_number datatype (D|N|T) “T” >
<!ELEMENT orig_maturity_date (#PCDATA)>
<!ATTLIST orig_maturity_date datatype (D|N|T) “D” >
<!ELEMENT orig_payment (#PCDATA)>
<!ATTLIST orig_payment datatype (D|N|T) “N” >
<!ELEMENT origion_date (#PCDATA)>
<!ATTLIST origion_date datatype (D|N|T) “D” >
<!ELEMENT vg_loan_acq
(acq_accr_int,acq_approved_by,acq_cred_risk_id,acq_date,acq_loan_number,acq_nbv,
acq_price,acq_proj_irr,acq_proj_resolution,acq_proj_roe,acq_proj_time,acq_total_upb,
acq_upb_secur,acq_upb_unsecur,investor_id,portfolio_id)>
<!ATTLIST vg_loan_acq relation (C|L) “C” >
<!ELEMENT acq_accr_int (#PCDATA)>
<!ATTLIST acq_accr_int datatype (D|N|T) “N” >
<!ELEMENT acq_approved_by (#PCDATA)>
<!ATTLIST acq_approved_by datatype (D|N|T) “T” >
<!ELEMENT acq_cred_risk_id (#PCDATA)>
<!ATTLIST acq_cred_risk_id datatype (D|N|T) “N” >
<!ELEMENT acq_date (#PCDATA)>
<!ATTLIST acq_date datatype (D|N|T) “D” >
<!ELEMENT acq_loan_number (#PCDATA)>
<!ATTLIST acq_loan_number datatype (D|N|T) “T” >
<!ELEMENT acq_nbv (#PCDATA)>
<!ATTLIST acq_nbv datatype (D|N|T) “N” >
<!ELEMENT acq_price (#PCDATA)>
<!ATTLIST acq_price datatype (D|N|T) “N” >
<!ELEMENT acq_proj_irr (#PCDATA)>
<!ATTLIST acq_proj_irr datatype (D|N|T) “N” >
<!ELEMENT acq_proj_resolution (#PCDATA)>
<!ATTLIST acq_proj_resolution datatype (D|N|T) “T” >
<!ELEMENT acq_proj_roe (#PCDATA)>
<!ATTLIST acq_proj_roe datatype (D|N|T) “N” >
<!ELEMENT acq_proj_time (#PCDATA)>
<!ATTLIST acq_proj_time datatype (D|N|T) “N” >
<!ELEMENT acq_total_upb (#PCDATA)>
<!ATTLIST acq_total_upb datatype (D|N|T) “N” >
<!ELEMENT acq_upb_secur (#PCDATA)>
<!ATTLIST acq_upb_secur datatype (D|N|T) “N” >
<!ELEMENT acq_upb_unsecur (#PCDATA)>
<!ATTLIST acq_upb_unsecur datatype (D|N|T) “N” >
<!ELEMENT portfolio_id (#PCDATA)>
<!ATTLIST portfolio_id datatype (D|N|T) “N” >
<!ELEMENT vg_loan_resolution
(resol_cash_collect,resol_clos_cost,resol_date,resol_disc_premium,resol_esc_adv,resol_{—}
final_stat,resol_gross_sale_price,resol_int_accr,resol_irr,resol_nbv,resol_net_gain,resol_{—}
net_proceed,resol_roe,resol_susp,resol_timeline,resol_tot_cash_collect,resol_type_id,
resol_upb)>
<!ATTLIST vg_loan_resolution relation (C|L) “C” >
<!ELEMENT resol_cash_collect (#PCDATA)>
<!ATTLIST resol_cash_collect datatype (D|N|T) “N” >
<!ELEMENT resol_clos_cost (#PCDATA)>
<!ATTLIST resol_clos_cost datatype (D|N|T) “N” >
<!ELEMENT resol_date (#PCDATA)>
<!ATTLIST resol_date datatype (D|N|T) “D” >
<!ELEMENT resol_disc_premium (#PCDATA)>
<!ATTLIST resol_disc_premium datatype (D|N|T) “N” >
<!ELEMENT resol_esc_adv (#PCDATA)>
<!ATTLIST resol_esc_adv datatype (D|N|T) “N” >
<!ELEMENT resol_final_stat (#PCDATA)>
<!ATTLIST resol_final_stat datatype (D|N|T) “T” >
<!ELEMENT resol_gross_sale_price (#PCDATA)>
<!ATTLIST resol_gross_sale_price datatype (D|N|T) “N” >
<!ELEMENT resol_int_accr (#PCDATA)>
<!ATTLIST resol_int_accr datatype (D|N|T) “N” >
<!ELEMENT resol_irr (#PCDATA)>
<!ATTLIST resol_irr datatype (D|N|T) “N” >
<!ELEMENT resol_nbv (#PCDATA)>
<!ATTLIST resol_nbv datatype (D|N|T) “N” >
<!ELEMENT resol_net_gain (#PCDATA)>
<!ATTLIST resol_net_gain datatype (D|N|T) “N” >
<!ELEMENT resol_net_proceed (#PCDATA)>
<!ATTLIST resol_net_proceed datatype (D|N|T) “N” >
<!ELEMENT resol_roe (#PCDATA)>
<!ATTLIST resol_roe datatype (D|N|T) “N” >
<!ELEMENT resol_susp (#PCDATA)>
<!ATTLIST resol_susp datatype (D|N|T) “N” >
<!ELEMENT resol_timeline (#PCDATA)>
<!ATTLIST resol_timeline datatype (D|N|T) “T” >
<!ELEMENT resol_tot_cash_collect (#PCDATA)>
<!ATTLIST resol_tot_cash_collect datatype (D|N|T) “N” >
<!ELEMENT resol_type_id (#PCDATA)>
<!ATTLIST resol_type_id datatype (D|N|T) “N” >
<!ELEMENT resol_upb (#PCDATA)>
<!ATTLIST resol_upb datatype (D|N|T) “N” >
<!ELEMENT vg_loan_borrower_link
(borrower_id,guarantee_amount,guarantee_type_id,guarantor)>
<!ATTLIST vg _loan_borrower_link relation (C|L) “L” >
<!ELEMENT borrower_id (#PCDATA)>
<!ATTLIST borrower_id map (borr_num) “borr_num” >
<!ATTLIST borrower_id datatype (D|N|T) “N” >
<!ELEMENT guarantee_amount (#PCDATA)>
<!ATTLIST guarantee_amount datatype (D|N|T) “N” >
<!ELEMENT guarantee_type_id (#PCDATA)>
<!ATTLIST guarantee_type_id datatype (D|N|T) “N” >
<!ELEMENT guarantor (#PCDATA)>
<!ATTLIST guarantor datatype (D|N|T) “T” >
<!ELEMENT vg_loan_prop_link (lien_pos,prop_id,released)>
<!ATTLIST vg_loan_prop_link relation (C|L) “L” >
<!ELEMENT lien_pos (#PCDATA)>
<!ATTLIST lien_pos datatype (D|N|T) “N” >
<!ELEMENT prop_id (#PCDATA)>
<!ATTLIST prop_id map (prop_number) “prop_number” >
<!ATTLIST prop_id datatype (D|N|T) “N” >
<!ELEMENT released (#PCDATA)>
<!ATTLIST released datatype (D|N|T) “T” >

Referring to FIG. 4, after the XML documents 100, 102, 104 and 106 have been produced, they are transmitted to the domain entity controllers 36. The data within each of the documents is available to each of the controllers including Loan, Property, Borrower and Investor. Each of these controllers extracts the particular data relevant to that controller and that data is transmitted for storage in specified fields in the common format database 28.

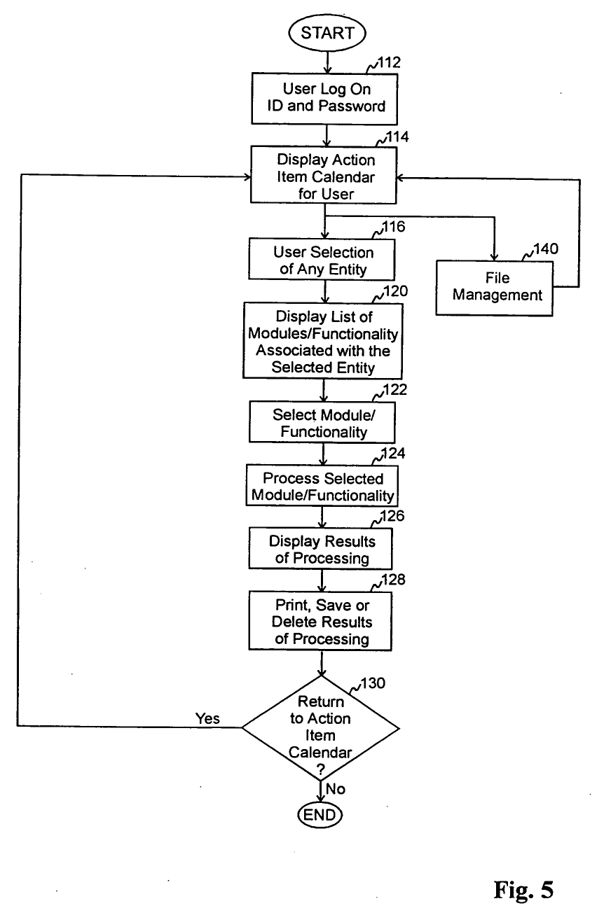

Referring to FIG. 5, there is shown a flow diagram representing a session of a user with the information and reporting system described herein. In block 112, the user logs on and provides his ID and password. If verified, the user receives a display of an action item calendar listing the action items associated with that user. This display further has a display of selections available to the user. This display includes a selection for any of the entities, which includes loans, properties, borrowers/guarantors, investors, companies and contacts.

Continuing to block 118, the user selects any one of these entities. In block 120, a display is produced for a list of modules/functionality associated with the selected entity. In block 122, the user selects one of the displayed modules or functionality. Continuing to block 124, the selected module or functionality is processed to produce the results required by that processing element. This can involve accessing information stored on the common format database 28 and can further involve the use of predetermined scenario formats, default formats and reports based upon business rules stored in the system. In block 126, the results of the processing are displayed and made available to the user. In block, 128, the user can manage the resulting information in any way desired such as by printing, saving, or if not required, deletion. Following completion of a particular module or functionality, entry is made to a question block 130 to determine if the user wishes to return to the action item calendar for further reviews of entities and processing functionality. If not, an exit is made.

The user can further select from the action item calendar a file management, such as shown in block 140. This can allow the user to review files and reports previous stored in the file repository 48. Upon completion of this activity, return is made to the action item calendar in block 114.

Although one embodiment of the invention has been illustrated in the accompanying drawings and described in the foregoing Detailed Description, it must be understood that the invention is not limited to the embodiment disclosed but is capable of numerous rearrangements, modifications and substitutions without departing from the scope of the invention.

1-12. (Cancelled).

13. A method for electronically facilitating entity management services, the method comprising:
assigning an asset manager to manage an entity;
providing a management timeline for the entity;
tracking defaults for the entity using the management timeline; and
creating at least one forecasting scenario for the entity using a plurality of parameters.

14. The method according to claim 13, further comprising:
providing contact information for the entity; and
creating conversation logs associated with the entity.

15. The method according to claim 13, further comprising:
generating correspondence regarding the entity; and
generating reports regarding the entity.

16. The method of claim 13,
wherein data regarding the entity is stored in a plurality of disparate legacy databases,
wherein a database mapper reads the data from the plurality of disparate legacy databases and writes the read data into a common format database, and
wherein a plurality of users access the data in the common format database via a plurality of applications.

17. The method of claim 13, wherein the entity is selected form a group consisting of a Loan, a Property, a Borrower and an Investor.

18. The method of claim 13, wherein providing the management timeline further comprises:
providing acquisition information for the entity;
providing a history of asset managers assigned to manage the entity;
providing a list of borrowers for the entity; and
providing a list of collaterals for the entity.

19. The method of claim 13, wherein the contact information is unique to the entity.

20. The method of claim 13, wherein the contact information is selected from a group consisting of telephone number, home address, business address, email address, and web site.

21. The method of claim 13, wherein the contact information further comprises a contact type.

22. The method of claim 21, wherein the contact type is selected from a group consisting of attorney, trustee, and receiver.

23. The method of claim 13, wherein the parameters are selected from a group consisting of principal, interest, default interest, service fees, expenses and cost of funds.

24. The method of claim 23, wherein the parameters may be customized according to the needs of the owner.

25. The method of claim 13, further comprising creating security restrictions for access to information regarding the entity.

26. A system for electronically facilitating entity management services, the system comprising:
means for assigning an asset manager to manage an entity;
means for providing a management timeline for the entity;
means for tracking defaults for the entity using the management timeline; and
means for creating at least one forecasting scenario for the entity using a plurality of parameters.

27. The system according to claim 26, further comprising:
means for providing contact information for the entity; and
means for creating conversation logs associated with the entity.

28. The system according to claim 26, further comprising:
means for generating correspondence regarding the entity; and
means for generating reports regarding the entity.

29. The system of claim 26,
wherein data regarding the entity is stored in a plurality of disparate legacy databases,
wherein a database mapper reads the data from the plurality of disparate legacy databases and writes the read data into a common format database, and
wherein a plurality of users access the data in the common format database via a plurality of applications.

30. The system of claim 26, wherein the entity is selected form a group consisting of a Loan, a Property, a Borrower and an Investor.

31. The system of claim 26, wherein the means for providing the management timeline further comprises:
means for providing acquisition information for the entity;
means for providing a history of asset managers assigned to manage the entity;
means for providing a list of borrowers for the entity; and
means for providing a list of collaterals for the entity.

32. The system of claim 26, wherein the parameters are selected from a group consisting of principal, interest, default interest, service fees, expenses and cost of funds.

33. A computer program product recorded in a computer readable medium for electronically facilitating entity management services, the computer program product comprising:
first computer readable program code means for assigning an asset manager to manage an entity;
second computer readable program code means for providing a management timeline for the entity;
third computer readable program code means for tracking defaults for the entity using the management timeline; and
fourth computer readable program code means for creating at least one forecasting scenario for the entity using a plurality of parameters.

34. The computer program product according to claim 33, further comprising:
fifth computer readable program code means for providing contact information for the entity; and
sixth computer readable program code means for creating conversation logs associated with the entity.

35. The computer program product according to claim 33, further comprising:
seventh computer readable program code means for generating correspondence regarding the entity; and
eighth computer readable program code means for generating reports regarding the entity.

36. The computer program product of claim 33,
wherein data regarding the entity is stored in a plurality of disparate legacy databases,
wherein a database mapper reads the data from the plurality of disparate legacy databases and writes the read data into a common format database, and
wherein a plurality of users access the data in the common format database via a plurality of applications.

37. The computer program product of claim 33, wherein the entity is selected form a group consisting of a Loan, a Property, a Borrower and an Investor.

38. The computer program product of claim 33, wherein the second computer readable program code means for providing the management timeline further comprises:
ninth computer readable program code means for providing acquisition information for the entity;
tenth computer readable program code means for providing a history of asset managers assigned to manage the entity;
eleventh computer readable program code means for providing a list of borrowers for the entity; and
twelfth computer readable program code means for providing a list of collaterals for the entity.

39. The computer program product of claim 33, wherein the parameters are selected from a group consisting of principal, interest, default interest, service fees, expenses and cost of funds.
